(19) United States
(12) Patent Application Publication
(10) Pub. No.: US 2015/0059330 A1
(43) Pub. Date: Mar. 5, 2015

(54) FLUID DELIVERY SYSTEM

(71) Applicant: Caterpillar Inc., Peoria, IL (US)

(72) Inventors: Balamurugesh Thirunavukarasu, Peoria, IL (US); Monte C. Cook, Morton, IL (US)

(73) Assignee: Caterpillar Inc., Peoria, IL (US)

(21) Appl. No.: 14/018,656

(22) Filed: Sep. 5, 2013

(51) Int. Cl. F15B 13/06

(52) U.S. Cl. CPC F15B 13/06
USPC 60/430; 60/486; 60/456; 60/464; 60/468

(57) ABSTRACT

A fluid delivery system includes a first hydraulic circuit, and a second hydraulic circuit. The first hydraulic circuit includes a first hydraulic pump, and a first hydraulic motor. The first hydraulic motor is fluidly connected to the first hydraulic pump and is configured to be driven by the first hydraulic pump. The second hydraulic circuit includes a second hydraulic pump, and a second hydraulic motor. The second hydraulic pump is mechanically coupled to the first hydraulic motor and configured to be driven by the first hydraulic motor. The second hydraulic motor is disposed in loop with the second hydraulic pump and configured to be driven by the second hydraulic pump. The fluid delivery system further includes a delivery pump mechanically coupled to the second hydraulic motor and fluidly connected to a fluid source. The delivery pump is configured to deliver a pressurized fluid.

### TECHNICAL FIELD

The present disclosure relates to a fluid delivery system, and more particularly, to a vehicle including the fluid delivery system for dispensing a pressurized fluid.

### BACKGROUND

Fluid distribution systems, in particular mobile fluid distribution systems, are used in a variety of applications. For example, at mining and construction sites, it is common to use mobile fluid distribution systems to spray water over roads and work areas to minimize the creation of dust during operations. A specific example might include a water truck that sprays water over roads at a mine site. Other applications of mobile fluid distribution systems may include spraying of pesticides and herbicides, e.g., for agricultural use, disbursement of saline solutions on roads for snow and ice control, fire suppression, and the like.

Typically, these fluid distribution systems are coupled to an engine directly or through a torque converter of the vehicle. The fluid distribution systems may be configured to vary a fluid output based upon a change in engine speed, a ground speed, or a speed of the torque converter. For example, U.S. Pat. No. 7,896,258 discloses a system and apparatus for controlling the delivery of fluid from a reservoir, in relation to the ground speed of the vehicle delivering the fluid.

However, when the size of the fluid dispensing vehicles and the corresponding engine and torque converter sizes increase, installation of the previously mentioned fluid delivery systems onto the engine or the torque converter may become difficult and cumbersome.

### SUMMARY

In one aspect of the present disclosure, a fluid delivery system includes a first hydraulic circuit, and a second hydraulic circuit. The first hydraulic circuit includes a first hydraulic pump, and a first hydraulic motor. The first hydraulic motor is fluidly connected to the first hydraulic pump and is configured to be driven by the first hydraulic pump. The second hydraulic circuit includes a second hydraulic pump, and a second hydraulic motor. The second hydraulic pump is mechanically coupled to the first hydraulic motor and configured to be driven by the first hydraulic motor. The second hydraulic motor is disposed in loop with the second hydraulic pump and configured to be driven by the second hydraulic pump. The fluid delivery system further includes a delivery pump mechanically coupled to the second hydraulic motor and fluidly connected to a fluid source. The delivery pump is configured to deliver a pressurized fluid.

In another aspect, the present disclosure provides a vehicle for dispensing pressurized fluid. The vehicle includes a frame, and a fluid delivery system disposed on the frame. The fluid delivery system includes a first hydraulic circuit, and a second hydraulic circuit. The first hydraulic circuit includes a first hydraulic pump, and a first hydraulic motor. The first hydraulic motor is fluidly connected to the first hydraulic pump and is configured to be driven by the first hydraulic pump. The second hydraulic circuit includes a second hydraulic pump, and a second hydraulic motor. The second hydraulic pump is mechanically coupled to the first hydraulic motor and configured to be driven by the first hydraulic motor. The second hydraulic motor is disposed in loop with the second hydraulic pump and configured to be driven by the second hydraulic pump. The fluid delivery system further includes a delivery pump mechanically coupled to the second hydraulic motor and fluidly connected to a fluid source. The delivery pump is configured to deliver a pressurized fluid.

Other features and aspects of this disclosure will be apparent from the following description and the accompanying drawings.

### BRIEF DESCRIPTION OF THE DRAWINGS

FIG. 1 is a perspective view of an exemplary vehicle in accordance with an exemplary embodiment of the present disclosure; and

FIG. 2 is a schematic representation of a fluid delivery system employed in the exemplary vehicle of FIG. 1.

### DETAILED DESCRIPTION

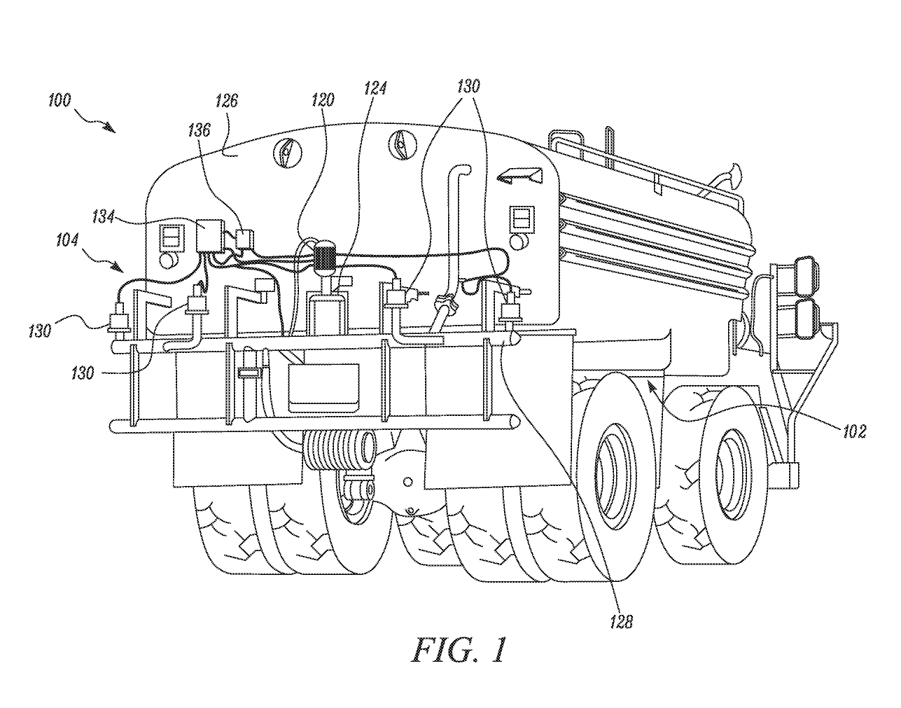

The present disclosure relates to a fluid delivery system, and more particularly, to a vehicle including the fluid delivery system for dispensing pressurized fluid. FIG. 1 illustrates an exemplary embodiment of a vehicle 100 according to the present disclosure. The vehicle 100 may be configured for dispensing a pressurized fluid. The vehicle 100 of FIG. 1 is shown as a truck, typically used in off-highway applications, converted to dispense a pressurized fluid. However, other types of mobile machines may be employed, for example, articulated trucks, on-highway trucks, tractor-scrapers, tractors in combination with trailers, or the like.

The vehicle 100 may include a variety of piping, hoses, pumps and valves for fluid transmission and/or distribution purposes. In particular, the vehicle 100 in FIG. 1 is shown as an off-highway truck configured as a water truck for spraying water at a work site. However, the present disclosure may also apply to other types of mobile machines configured to distribute water or other types of fluids in a wide variety of applications. For example, a tractor pulling a trailer may be used to distribute chemicals in agricultural settings, an on-highway truck may be configured to spray a saline solution on roads, runways, or parking lots to melt snow and ice, or other varieties of applications and setups may be used.

In an embodiment, the vehicle 100 may include an engine (not shown), such as an internal combustion engine or other power source, which may be supported on a frame 102. Although different arrangements and setups are contemplated, the vehicle 100 may include among other systems, a fluid delivery system 104 disposed on the frame 102 as shown in FIG. 1. The fluid delivery system 104 may be powered by the engine. Further, the engine may be configured to provide power to a number of other systems and devices (not shown) in addition to the fluid delivery system 104. The fluid delivery system 104 may include a fluid source 126 and one or more spray heads 130 fluidly connected thereto, explaining to which will be made hereinafter.

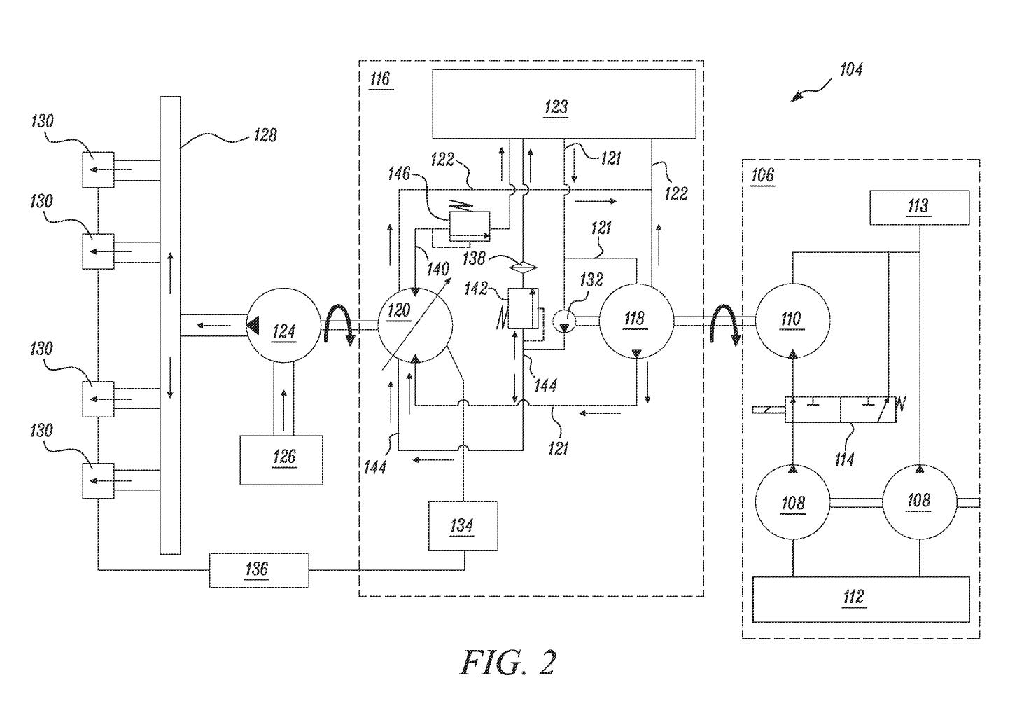

Referring now to FIG. 2, details pertaining to the fluid delivery system 104 will be disclosed hereinafter. The fluid delivery system 104 includes a first hydraulic circuit 106. The first hydraulic circuit 102 includes two first hydraulic pumps 108, and a first hydraulic motor 110. The first hydraulic motor 110 is fluidly connected to the first hydraulic pumps 108 and is configured to be driven by the first hydraulic pump 108.

For purposes of illustration, two first hydraulic pumps 108 have been shown in FIG. 2. However, it is to be noted that the number of first hydraulic pumps shown in FIG. 2 is merely exemplary in nature and hence, non-limiting of this disclosure. Any number of hydraulic pumps may be used in the first hydraulic circuit 106 depending on specific requirements of an application.

The first hydraulic circuit 106 may further comprise a first tank 112 configured to store a first working fluid. In an embodiment, the first hydraulic circuit 106 may further comprise a control valve 113 disposed in loop with the first hydraulic pumps 108 and the first hydraulic motor 110. The control valve 113 may be configured to control the first working fluid that circulates from the first hydraulic pumps 108 and the first hydraulic motor 110 to other applications on the vehicle 100.

In an embodiment, the first hydraulic circuit 106 may further include a bypass valve 114 disposed between the control valve 113 and the first hydraulic pumps 108. Further, the bypass valve 114 may be fluidly connected to the control valve 113 and the first hydraulic pumps 108. The bypass valve 114 may be configured to allow the first working fluid from the first hydraulic pumps 108 to enter or bypass the first hydraulic motor 110. In an exemplary embodiment, the bypass valve 114 may be a 2-way, 2-position valve. However, the 2-way, 2-position valve is merely exemplary in nature and hence, non-limiting of this disclosure. Any type of valve commonly known in the art may be used to form the bypass valve 114. An operational state of the fluid delivery system 104 may be controlled by operating the bypass valve 114. Explanation pertaining to the functioning and control of the fluid delivery system 104 by operation of the bypass valve 114 will be made later herein.

The fluid delivery system 104 further includes a second hydraulic circuit 116 including a second hydraulic pump 118, and a second hydraulic motor 120. The second hydraulic pump 118 is mechanically coupled to the first hydraulic motor 110 and is configured to be driven by the first hydraulic motor 110. The second hydraulic motor 120 is disposed in loop with the second hydraulic pump 118 and configured to be driven by the second hydraulic pump 118. As shown in FIG. 2, the second hydraulic pump 118 is fluidly connected to and disposed in loop with the second hydraulic motor 120 by a primary input line 121 and a drain line 122.

The second hydraulic circuit 116 further includes a second tank 123 disposed in loop with and fluidly connected to the second hydraulic pump 118, and the second hydraulic motor 120. The second tank 123 may be configured to store a second working fluid. The second working fluid may be circulated from the second tank 123 to the second hydraulic pump 118, and the second hydraulic motor 120 via the primary input line 121 and the drain line 122.

The fluid delivery system 104 further includes a delivery pump 124 mechanically coupled to the second hydraulic motor 120 and fluidly connected to the fluid source 126 (as shown in FIG. 2 and also in FIG. 1). The delivery pump 124 is configured to deliver a pressurized fluid. In an embodiment, the fluid source 126 may be a third tank configured to store a third fluid different from the first working fluid and the second working fluid. For ease in referring to the fluid source 126, “the fluid source” may hereinafter be referred to as “the third tank”. Further, the numeral 126 designating “the fluid source” may be correspondingly used to designate “the third tank”. Furthermore, with reference to the embodiments disclosed herein, it may be noted that the first tank (112) associated with the first hydraulic circuit (106), the second tank (123) associated with the second hydraulic circuit (116), and the third tank (126) connected to the delivery pump (124) are hydraulically isolated from each other. The first hydraulic circuit (106), the second hydraulic circuit (116), and the third tank (126) may thus operate without any fluid-mixing or exchange therebetween.

In an embodiment, as shown in FIGS. 1-2, the fluid delivery system 104 further includes a fluid manifold 128, and the spray heads 130 mounted onto the fluid manifold 128 (four spray heads 130 shown in FIGS. 1-2). The fluid manifold 128 (as shown in FIGS. 1-2) may be fluidly coupled to the delivery pump 124 and configured to receive the pressurized fluid from the delivery pump 124. The spray heads 130 may be configured to dispense the pressurized fluid. Although four spray heads 130 are shown in FIG. 2, it is to be noted that a number of spray heads mounted onto the fluid manifold 128 is merely exemplary in nature and hence, non-limiting of this disclosure. Any number of spray heads may be employed in the fluid delivery system 104 depending on specific requirements of an application.

In an embodiment, as shown in FIG. 2, the second hydraulic motor 120 may be a variable displacement hydraulic motor (as indicated by a slant arrow on circle representing the second hydraulic motor 120). The second hydraulic circuit 116 may further include a control pump 132 mechanically coupled to the second hydraulic pump 118. The control pump 132 is disposed in loop with the second hydraulic motor 120 and is configured to provide a control pressure to the second hydraulic motor 120. The control pump 132 may be further configured to provide flow to a cooler 138 thereby cooling the second working fluid in the second tank 123.

In another embodiment as shown in FIGS. 1-2, the fluid delivery system 104 may further include an electronic control module (ECM) 134 electrically connected to the second hydraulic motor 120. In an embodiment, the ECM 134 may control one or more actuators (not shown) associated with the second hydraulic motor 120 using the control pressure from the control pump 132 as a reference. Further, the ECM 134 may be electrically connected to a pressure sensor (not shown) located at the fluid manifold 128 and spray heads 130 via one or more solenoids 136.

The ECM 134 may be configured to modulate a speed of the second hydraulic motor 120 such that a fluid output from the delivery pump 124 is varied, i.e., a flow rate and/or pressure of the third fluid from the delivery pump 124 are varied. Varying the fluid output from the delivery pump 124 may increase or decrease a pressure of the third fluid in the fluid manifold 128 such that the spray heads 130 may dispense the third fluid at an increased or decreased flow rate and/or pressure.

In one exemplary embodiment, the variation in the flow rate or pressure of the third fluid may be based on the speed of the vehicle 100. In another exemplary embodiment, the variation in the flow rate or pressure of the third fluid may be based on one or more operator inputs, wherein an operator may command the ECM 134 with the required input signals.

In an embodiment as shown in FIG. 2, the second hydraulic circuit 116 may further include the cooler 138 disposed downstream of the control pump 132. The cooler 138 may be configured to cool the second working fluid returning from the second hydraulic motor 120.

The second hydraulic circuit 116 may further include a relief valve 142 disposed between the cooler 138, the control pump 132, and the second hydraulic motor 120. The relief valve 142 may be fluidly connected to the cooler 138, the control pump 132, and the second hydraulic motor 120. As shown in FIG. 2, the relief valve 142 may be disposed in a control input line 144 of the second hydraulic motor 120. The relief valve 142 may be configured to maintain a control pressure of the second working fluid in the control input line 144.

The relief valve 142 may be preset with a threshold pressure. Based on a pressure of the second working fluid in relation to the threshold pressure of the relief valve 142, the relief valve 142 may be forced open or closed to maintain the threshold pressure in the control input line 144 of the second hydraulic motor 120. Hence, the relief valve 142 may bleed off excess pressure build-up from prolonged or constant pumping of the second working fluid within the control input line 144 of the second hydraulic circuit 116 through the cooler 138.

In an embodiment, the second hydraulic circuit 116 may further include a back-pressure valve 146 disposed in the primary output line 140. The back-pressure valve 146 may be located between the second hydraulic motor 120 and the second tank 123. The back-pressure valve 146 may be configured to maintain a threshold pressure in the primary output line 140. This threshold pressure in the primary output line 140 may help to send a small portion of the second working fluid to the drain line 122 through the second hydraulic motor 120 thereby cooling the second hydraulic motor 120.

### INDUSTRIAL APPLICABILITY

Fluid delivery systems may be used in a number of different applications to deliver, and distribute, various fluids. For example, in mobile applications, a fluid delivery machine, or truck, may use a fluid delivery system to distribute a liquid, such as water, at construction or mining sites to reduce dust. In particular, for example, a fluid delivery machine may distribute water along haul roads at a work site to minimize the creation of dust during work operations. A working of the present fluid delivery system 104 will be disclosed hereinafter.

To initiate operation of the fluid delivery system 104, the bypass valve 114 may be set into a first position such that the bypass valve 114 is configured to allow the first working fluid from the first hydraulic pumps 108 to enter the first hydraulic motor 110. Therefore, the first working fluid, supplied to the first hydraulic pumps 108 by the first tank 112, may be pressurized to drive the first hydraulic motor 110.

Rotation of the first hydraulic motor 110 may rotate the second hydraulic pump 118 and the control pump 132. The second hydraulic pump 118 and the control pump 132 may be supplied with the second working fluid from the second tank 123. The second hydraulic pump 118 pressurizes the second working fluid to drive the second hydraulic motor 120. The control pump 132 pressurizes the second working fluid to provide a control pressure to the second hydraulic motor 120 via the control input line 144 and flow to the cooler 138 to cool the second fluid in the tank 123.

Rotation of the second hydraulic motor 120 drives the delivery pump 124. Therefore, the third fluid supplied to the delivery pump 124 by the third tank 126 is pressurized and sent to the fluid manifold 128. Thereafter, the spray heads 130 mounted on the fluid manifold 128 may dispense fluid at a pressure and/or flow rate corresponding to the speed of the second hydraulic motor 120.

When a pressure of the third fluid dispensed from the spray heads 130 is to be varied, the ECM 134 may modulate a speed of the second hydraulic motor 120 based upon various input signals from one or more sensors and vehicle operator. For example, based upon input signals from vehicle speed sensors (not shown) and input signals from various pressure and/or position sensors (not shown) associated with the spray heads 130, the ECM 134 may command movement of the solenoids 136 in a desired position and/or the second hydraulic motor 120 at a desired speed to maintain a certain flow rate out of the spray heads 130.

The ECM 134 may embody a single microprocessor or multiple microprocessors that include components for controlling operation of the fluid delivery system 104 based on an input signals from an operator and/or based on sensed or other known operational parameters. Numerous commercially available microprocessors can be configured to perform the functions of the ECM 134. It should be appreciated that the ECM 134 could readily be embodied in a general machine microprocessor capable of controlling numerous machine functions. The ECM 134 may include a memory, a secondary storage device, a processor, and any other components for running an application. Various other circuits may be associated with the ECM 134 such as power supply circuitry, signal conditioning circuitry, solenoid driver circuitry, and other types of circuitry. Further, various routines, algorithms, and/or programs may be programmed within the ECM 134 for execution thereof to perform the functions of controlling the solenoids 136 and/or the second hydraulic motor 120.

In order to stop an operation of the fluid delivery system 104, the bypass valve 114 may be set into a second position such that the bypass valve 114 is configured to allow the first working fluid from the first hydraulic pumps 108 to directly flow to the control valve 113 thereby causing the first working fluid to bypass the first hydraulic motor 110. Therefore, the first hydraulic motor 110, the second hydraulic pump 118, the second hydraulic motor 120, and the delivery pump 124 may not be driven by the first hydraulic pump 108. Consequently, the spray heads 130 may not dispense fluid, thus rendering the fluid delivery system 104 in a non-operational state.

The back-pressure valve 146, the cooler 138, and the relief valve 142 disclosed herein may be employed in the fluid delivery system 104 to regulate parameters such as pressure, temperature, and/or flow rate of the second working fluid in the second hydraulic circuit 116. Control and regulation of the second working fluid may allow smooth operation and facilitate prolonged operation cycles of the fluid delivery system 104.

Previously known fluid distribution systems were coupled to an engine or a torque converter of a water tanker. However, with increase in size of the water tanker, a size of the engine and the torque converter may increase, and consequently the space available in and around the engine or the torque converter for installation of the previously known fluid distribution systems may reduce. The reduced space may make installation of the previously known fluid distribution systems onto the engine or the torque converter difficult and cumbersome.

In one aspect of the present disclosure, the first hydraulic pump 108 may be a pump that existed as a part of the vehicle 100 prior to the vehicle 100 being configured for dispensing pressurized fluid. For example, the vehicle 100 may have previously been used as a dump truck employing one or more hoist/brake cooling pumps therein. The hoist/brake cooling pumps may have been associated with a hoisting implement or were used for cooling the brakes of the dump truck. With implementation of the fluid delivery system 104 of the present disclosure, the hoist/brake cooling pumps may be used to form the first hydraulic pumps 108, and the first hydraulic pumps 108 formed from the hoist/brake cooling pumps may be disposed in connection with the remaining components of the fluid delivery system 104 disclosed herein. In this manner, the fluid delivery system 104 may be configured to have indirect association with the engine or the torque converter of the vehicle 100. Further, the construction of the fluid delivery system 104 disclosed herein may dispose the fluid delivery system 104 substantially away from the engine or the torque converter.

In another aspect of the preceding embodiment, the first working fluid, the second working fluid, and the third fluid associated with the first hydraulic circuit 106, the second hydraulic circuit 116, and the delivery pump 124, respectively, may be distinct from each other. The first hydraulic circuit 106 employing the hoist/brake cooling pumps as the first hydraulic pumps 108 may use a fluid, for example, an oil previously associated with a hoisting/brake cooling arrangement circuit of the vehicle 100. The second working fluid may be, for example, oil associated with a steering equipment of the vehicle 100. The third fluid may be, for example, water, or a pesticide liquid that is to be dispensed onto a ground surface (not shown).

Oil associated with a circuit, such as the hoisting/brake cooling arrangement circuit of the vehicle 100 is typically known to get contaminated or dirty over a prolonged period of time. Components used in the second hydraulic circuit 116 such as the hydraulic motor 120 for example, may be sensitive to oil contaminants and a life of the components may reduce with an increase in amount of oil contaminants.

However, with use of the first, second, and third tanks 112, 123, 126, and the distinct fluids circulated therefrom, it is envisioned that the first hydraulic circuit 106, the second hydraulic circuit 116, and the delivery pump 124 may operate individually without mixing of the first working fluid, the second working fluid, and the third fluid therebetween. Therefore, the distinct tanks 112, 123, 126 and the distinct fluids circulated therefrom may help to keep contaminants of each fluid within the respective hydraulic circuits 106, 116, and to the delivery pump 124 respectively. As a result, a service life of the components used in the hydraulic circuits may be prolonged. Further, it may be easier to circulate the fluids of the respective hydraulic circuits 106, 116 and the delivery pump 124 and accomplish smooth operation of the fluid delivery system 104.

The construction of the fluid delivery system 104 disclosed herein and the configuration of various components therein may allow a manufacturer to overcome the space demands encountered with implementation of previously known fluid distribution systems onto engines and torque converters. The present fluid delivery system 104 may allow the manufacturer to do away with installing the fluid delivery system 104 onto the engines and torque converters.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

What is claimed is:

1. A fluid delivery system comprising:
a first hydraulic circuit comprising:
a first hydraulic pump; and
a first hydraulic motor fluidly connected to the first hydraulic pump and configured to be driven by the first hydraulic pump;
a second hydraulic circuit comprising:
a second hydraulic pump mechanically coupled to the first hydraulic motor and configured to be driven by the first hydraulic motor; and
a second hydraulic motor disposed in loop with the second hydraulic pump and configured to be driven by the second hydraulic pump; and
a delivery pump mechanically coupled to the second hydraulic motor and fluidly connected to a fluid source, the delivery pump configured to deliver a pressurized fluid.

2. The fluid delivery system of claim 1, wherein the second hydraulic motor is a variable displacement hydraulic motor, and wherein the second hydraulic circuit further comprises a control pump mechanically coupled to the second hydraulic pump and disposed in loop with the second hydraulic motor, the control pump configured to provide a control pressure to the second hydraulic motor.

3. The fluid delivery system of claim 2, wherein the second hydraulic circuit further comprises:
a cooler disposed downstream of the control pump, the cooler configured to receive a flow of second fluid from the control pump to cool the second fluid in the second hydraulic circuit; and
a relief valve disposed between and fluidly connected to the cooler, the control pump, and the second hydraulic motor.

4. The fluid delivery system of claim 1 further comprising an electronic control module electrically connected to the second hydraulic motor, the electronic control module configured to modulate a speed of the second hydraulic motor such that a fluid output from the delivery pump is varied.

5. The fluid delivery system of claim 1, wherein the first hydraulic circuit further comprises a first tank configured to store a first working fluid, wherein the second hydraulic circuit further comprises a second tank configured to store a second working fluid, and wherein the fluid source is a third tank configured to store a third fluid.

6. The fluid delivery system of claim 5, wherein the first tank associated with the first hydraulic circuit, the second tank associated with the second hydraulic circuit, and the third tank connected to the delivery pump are hydraulically isolated from each other.

7. The fluid delivery system of claim 5, wherein the first tank is disposed in loop with and fluidly connected to the first hydraulic pump and the first hydraulic motor, wherein the second tank is disposed in loop with and fluidly connected to the second hydraulic pump and the second hydraulic motor, and wherein the third tank is fluidly connected to the delivery pump.

8. The fluid delivery system of claim 5, wherein the second hydraulic circuit further comprises a back-pressure valve disposed in a primary output line of the second hydraulic motor and in between the second hydraulic motor and the second tank.

9. The fluid delivery system of claim 5, wherein the first hydraulic circuit further comprises a bypass valve disposed between and fluidly connected with a control valve and the first hydraulic pump.

10. The fluid delivery system of claim 1 further comprising:
a fluid manifold fluidly coupled to the delivery pump and configured to receive the pressurized fluid from the delivery pump; and
a spray head mounted onto the fluid manifold, the spray head configured to dispense the pressurized fluid.

11. A vehicle for dispensing pressurized fluid, the vehicle comprising:
a frame;
a fluid delivery system disposed on the frame, the fluid delivery system comprising:
a first hydraulic circuit comprising:
a first hydraulic pump; and
a first hydraulic motor fluidly connected to the first hydraulic pump and configured to be driven by the first hydraulic pump;
a second hydraulic circuit associated with the second tank, the second hydraulic circuit comprising:
a second hydraulic pump mechanically coupled to the first hydraulic motor and configured to be driven by the first hydraulic motor; and
a second hydraulic motor disposed in loop with the second hydraulic pump and configured to be driven by the second hydraulic pump; and
a delivery pump associated with the mechanically coupled to the second hydraulic motor and fluidly connected to a fluid source, the delivery pump configured to deliver a pressurized fluid.

12. The vehicle of claim 11, wherein the second hydraulic motor is a variable displacement hydraulic motor, and wherein the second hydraulic circuit further comprises a control pump mechanically coupled to the second hydraulic pump and disposed in loop with the second hydraulic motor, the control pump configured to provide a control pressure to the second hydraulic motor.

13. The vehicle of claim 12, wherein the second hydraulic circuit further comprises:
a cooler disposed downstream of the control pump, the cooler configured to receive a flow of second fluid from the control pump to cool the second fluid in the second hydraulic circuit; and
a relief valve disposed between and fluidly connected to the cooler, the control pump, and the second hydraulic motor.

14. The vehicle of claim 11, wherein the fluid delivery system further comprises an electronic control module electrically connected to the second hydraulic motor, the electronic control module configured to modulate a speed of the second hydraulic motor such that a fluid output from the delivery pump is varied.

15. The vehicle of claim 11, wherein the first hydraulic circuit further comprises a first tank configured to store a first working fluid, wherein the second hydraulic circuit further comprises a second tank configured to store a second working fluid, and wherein the fluid source is a third tank configured to store a third fluid.

16. The vehicle of claim 15, wherein the first tank associated with the first hydraulic circuit, the second tank associated with the second hydraulic circuit, and the third tank connected to the delivery pump are hydraulically isolated from each other.

17. The vehicle of claim 15, wherein the first tank is disposed in loop with and fluidly connected to the first hydraulic pump and the first hydraulic motor, wherein the second tank is disposed in loop with and fluidly connected to the second hydraulic pump and the second hydraulic motor, and wherein the third tank is fluidly connected to the delivery pump.

18. The vehicle of claim 15, wherein the second hydraulic circuit further comprises a back-pressure valve disposed in a primary output line of the second hydraulic motor and in between the second hydraulic motor and the second tank.

19. The vehicle of claim 15, wherein the first hydraulic circuit further comprises a bypass valve disposed between and fluidly connected with a control valve and the first hydraulic pump.

20. The vehicle of claim 11, wherein the fluid delivery system further comprises:
a fluid manifold fluidly coupled to the delivery pump and configured to receive the pressurized fluid from the delivery pump; and
a spray head mounted onto the fluid manifold, the spray head configured to dispense the pressurized fluid.
